(19) United States
(12) Patent Application Publication
(10) Pub. No.: US 2025/0361098 A1
(43) Pub. Date: Nov. 27, 2025

(54) SYSTEMS AND METHODS FOR OBJECT PROCESSING WITH PROGRAMMABLE MOTION DEVICES USING MULTIPLE ASSISTIVE END-EFFECTORS

(71) Applicant: Berkshire Grey Operating Company, Inc., Bedford, MA (US)

(72) Inventors: John Richard AMEND, JR., Arlington, MA (US); Christopher GEYER, Arlington, MA (US); Matthew T. MASON, Atlanta, GA (US); Noah James Slade MAYNARD, Exeter, NH (US); Ryan O'HERN, Reading, MA (US); Joseph ROMANO, Arlington, MA (US); Thomas WAGNER, Concord, MA (US)

(21) Appl. No.: 19/216,883

(22) Filed: May 23, 2025

Related U.S. Application Data
(60) Provisional application No. 63/651,967, filed on May 25, 2024.

(51) Int. Cl. B65G 47/90

(52) U.S. Cl. CPC B65G 47/905

(57) ABSTRACT

An end-effector system for use with a programmable motion device is disclosed. The end-effector system includes a first end-effector for performing a task of grasping and moving an object from an input area to an output area, the first end-effector including a vacuum cup gripper, a second end-effector for grasping and moving the object to assist the task performed by the first end-effector, said second end-effector including a non-vacuum gripper, and a control system comprising at least one camera for detecting movement of the object associated with the task, the control system directing the second end-effector to contact the object and move in a motion corresponding to the movement of the object associated with the task, and the control system directing the first end-effector for grasping the object and the second end-effector for contacting the object to cooperatively move the object to the output area to complete the task.

### PRIORITY

The present application claims priority to U.S. Provisional Patent Application 63/651,967 filed May 25, 2024, the disclosure of which is hereby incorporated by reference in its entirety.

### BACKGROUND

The invention generally relates to programmable motion systems and relates in particular to end-effectors for programmable motion devices (e.g., robotic systems) for use in object processing systems such as object sortation systems.

End-effectors for robotic systems may be employed, for example, in certain applications to select and grasp an object, and then move the acquired object very quickly to a new location. End-effectors should be designed to quickly and easily select and grasp a single object from a jumble of dissimilar objects, and should be designed to securely grasp an object during movement. Certain end-effectors, when used on different objects of different physical sizes, weights and materials, may have limitations regarding how securely they may grasp an acquired object, and how securely they may maintain the grasp on the object during rapid movement, particularly rapid acceleration and deceleration (both angular and linear).

Many end-effectors employ vacuum pressure for acquiring and securing objects for transport, orientation, placement, manipulation and/or subsequent operations by articulated arms. Other techniques for acquiring and securing objects involve electrostatic attraction, magnetic attraction, needles for penetrating objects such as fabrics, fingers that grasp an object, hooks that engage and lift a protruding feature of an object, and collets that expand in an opening of an object, among other techniques.

In applications where vacuum pressure is used to acquire and secure objects, an end-effector on an articulated arm may include a vacuum cup having a compliant portion, e.g., a bellows portion that contacts the object to be grasped. The compliant portion may be formed of a polymeric or elastomeric material that is flexible enough to allow it to change its shape to adapt to variations in object surface structures, and to varying physical relationships between the articulated arm and the object, such as for example varying angles of approaches to objects. The flexibility further allows the vacuum cup to conform to the shape of objects or to wrap around corners of objects to create an adequate seal for acquiring and securing the object. When a good seal is not created between a flexible vacuum cup and an object, the system may not be able to achieve the required vacuum level or sometimes it may create a substantial amount of noise due to positioning of the vacuum cup on the object and the types of vacuum used.

Other types of end-effectors including vacuum cups with less flexible compliant portions (in addition to those using electrostatic attraction, magnetic attraction, needles for penetrating objects such as fabrics, fingers that squeeze an object, hooks that engage and lift a protruding feature of an object, and collets that expand in an opening of an object), are less effective at acquiring and moving a wide variety of objects in certain applications.

Such applications in which a robotic system needs to grasp and move a wide variety of objects relative to an environment include, for example, sorting and otherwise processing a wide variety of objects with varying processing requirements.

There remains a need therefore, for systems and methods for more efficiently and effectively maintaining and packing objects by efficiently adjusting placement pose or orientation of objects without adversely impacting throughput.

### SUMMARY

In accordance with an aspect, the invention provides an end-effector system for use with a programmable motion device that includes a first end-effector for performing a task of grasping and moving an object from an input area to an output area, the first vacuum end-effector including a vacuum cup gripper. The system includes a second end-effector for grasping and moving the object to assist the task performed by the first end-effector, said second end-effector including a non-vacuum gripper, and the system includes a control system that has at least one camera for detecting movement of the object associated with the task, the control system directing the second end-effector to contact the object and move in a motion corresponding to the movement associated with the task, and the control system directing the first end-effector for grasping the object and the second end-effector for contacting the object to cooperatively move the object to the output area to complete the task.

In accordance with another aspect, the invention provides an object processing system that includes a first programmable motion device with a first end-effector for performing a task of grasping and moving an object from an input area to an output area and a second programmable motion device with a second end-effector for engaging and moving the object to assist the task performed by the first end-effector, the second end-effector of the second programmable motion device including different functionality than that of the first end-effector of the first programmable motion device. The system also includes a control system having at least one camera for detecting movement of the object by the first end-effector of the first programmable motion device and directing the second programmable motion device to engage the object with the second end-effector of the second programmable motion device while the object is moving, the control system directing the first programmable motion device and the second programmable motion device for cooperatively moving the object to the output area to complete the task.

In accordance with a further aspect, the invention provides a method of processing objects with a first programmable motion device and a second programmable motion device. The method includes grasping and moving an object from an input area using a first end-effector of the first programmable motion device, the first end-effector using a first functionality for grasping and moving the object, determining that the second programmable motion device with a second end-effector is needed to assist the first programmable motion device in grasping and moving the object, the second end-effector using a second functionality for grasping and moving the object that is different than the first functionality, and contacting the object with the second end-effector while the object is moving to assist in moving the object by the first programmable motion device.

### BRIEF DESCRIPTION OF THE DRAWINGS

The following description may be further understood with reference to the accompanying drawings in which:

FIG. 1 shows an illustrative diagrammatic view of an autonomous object processing system with first and second programmable motion devices in accordance with an aspect of the present invention.

FIG. 2 shows an illustrative diagrammatic enlarged view of the end-effector system of FIG. 1;

FIG. 3 shows an illustrative diagrammatic further enlarged view of the end-effector system of FIG. 2;

FIGS. 4A-4D show an illustrative diagrammatic view of an illustrative example of an aspect of the end-effector system of FIG. 1, showing a large object being lifted and exhibiting unstable movement (FIG. 4A), showing a positioning of a second end-effector responsive to the detection of unstable movement (FIG. 4B), showing the second end-effector moving to a stabilizing position (FIG. 4C), and showing the large object being moved while stabilized (FIG. 4D);

FIGS. 5A-5B show illustrative diagrammatic views of a further aspect of the end-effector system of FIG. 1, showing a large objecting being stabilized by the second end-effector (FIG. 5A), and showing the second end-effector moving aside while the object is oriented and placed into a destination container (FIG. 5B);

FIGS. 6A-6D show illustrative diagrammatic views of a non-rigid object being gasped by the first end-effector (FIG. 6A), showing a positioning of a second end-effector responsive to the detection of the object being non-rigid (FIG. 6B); showing the second end-effector moving to a stabilizing position (FIG. 6C), and showing the non-rigid object being moved while stabilized (FIG. 6D);

FIGS. 7A-7B show illustrative diagrammatic views of a non-rigid object being grasped by the first end-effector in a different orientation such that it falls open in a different direction (FIG. 7A), and showing the second end-effector moving to a stabilizing position (FIG. 7B);

FIGS. 8A-8D show illustrative diagrammatic views of a stacked set of objects being gasped by the first end-effector (FIG. 8A), showing the second end-effector being used to grasp and separate at least one object from the stacked set of objects held by the first end-effector (FIG. 8B), showing a single separated object form the stacked set of objects being moved (FIG. 8C), and showing the single separate object being moved to a further destination location (FIG. 8D);

FIG. 9 shows an illustrative diagrammatic front view of an autonomous object processing system in accordance with a further aspect of the present invention that includes a third programmable motion device with a third end-effector;

FIG. 10 shows an illustrative diagrammatic side view of the third programmable motion device with the third end-effector fully extended;

FIGS. 11A and 11B show illustrative diagrammatic views of the system of FIG. 9, showing the third end-effector engaging an object (FIG. 11A) and repositioning the first and second end-effectors while the third end-effector holds the object (FIG. 11B);

FIG. 12 shows an illustrative diagrammatic view of an anthropomorphic end-effector for use as a second end-effector in the system of FIG. 1 or FIG. 9 showing the fingers curved;

FIG. 13 shows an illustrative diagrammatic view of an anthropomorphic end-effector for use as a second end-effector in the system of FIG. 1 or FIG. 9 showing the fingers splayed and rotated;

FIG. 14 shows an illustrative diagrammatic partial cutaway view of a portion of an anthropomorphic end-effector for use in accordance with an aspect of the present invention that includes pneumatic actuators;

FIG. 15 shows an illustrative diagrammatic partially exploded view of a portion of an anthropomorphic end-effector for use in accordance with another aspect of the present invention that includes vacuum actuators;

FIGS. 16A-16D show illustrative diagrammatic views of an end-effector system in accordance with a further aspect of the present invention showing a first end-effector gasping an object (FIG. 16A), showing a second end-effector also grasping the object (FIG. 16B), showing the first end-effector letting go of the object so that the object may be repositioned (FIG. 16C), and showing the object being placed into a container (FIG. 16D);

FIG. 17 shows an illustrative diagrammatic view of an end-effector selection rack positioned proximate the first end-effector;

FIG. 18 shows an illustrative diagrammatic view of an end-effector selection rack positioned proximate the second end-effector;

FIGS. 19A-19F show illustrative views of a flow chart showing an operation of the end-effector system for programmable motion devices of the system of FIG. 1; and

FIG. 20 shows an illustrative diagrammatic view of the system of FIG. 1 wherein all input objects are processed by the system.

The drawings are shown for illustrative purposes.

### DETAILED DESCRIPTION

In accordance with various aspects, the invention provides an end-effector system for programmable motion devices (e.g., robotic systems) that uses vacuum to grasp objects. Vacuum may be supplied as high vacuum at low flow that requires a seal to provide a strong, stable grip, or vacuum may be supplied as high flow vacuum that is able to grasp objects without requiring a seal. The high flow vacuum is provided at a vacuum cup of the end-effector system that is coupled to a high flow vacuum system. The vacuum cup is attached to a cup attachment portion, which is in turn attached to an arm attachment portion that is attached to an articulated arm of the robotic system.

Generally, in an autonomous, object processing systems, objects need to be identified and conveyed to desired object specific locations. The systems rely on robotic systems with end-effector systems to reliably automate the identification and conveyance of a vast array of objects using a variety of material handling subsystems including conveyors, perception systems, storage arrays, and storage containers or bins. Ultimately, the desired object specific location will be a box or container into which the object is placed for its conveyance to the customer for order fulfillment or to its intended use in a production environment. The flexibility of end-effector systems to reliably handle the vast array of items or SKUs (objects) can be challenging. Any one end-effector is typically not suitable for all SKUs to be handled by the robotic systems. The task of grasping and moving objects often requires either manual assistance or a time-consuming preparatory task of changing the end-effector to one that is suitable for a particular object.

Autonomous object processing systems typically require significant capital expense that can only be justified with commensurate productivity gains. Factors considered in the justification of capital investment in autonomous object processing systems include throughput (e.g., number of items picked/processes per hour), physical space utilization, and annualized costs for installation, operation, and maintenance. Factors that influence throughput include flexibility of robotic systems to handle a wide variety of items without downtime for tooling changes, as well as the number of robotic systems that simultaneously process items in parallel with each other. Manual (or human) intervention in terms of frequency and duration per occurrence negatively impact the throughput of any given system.

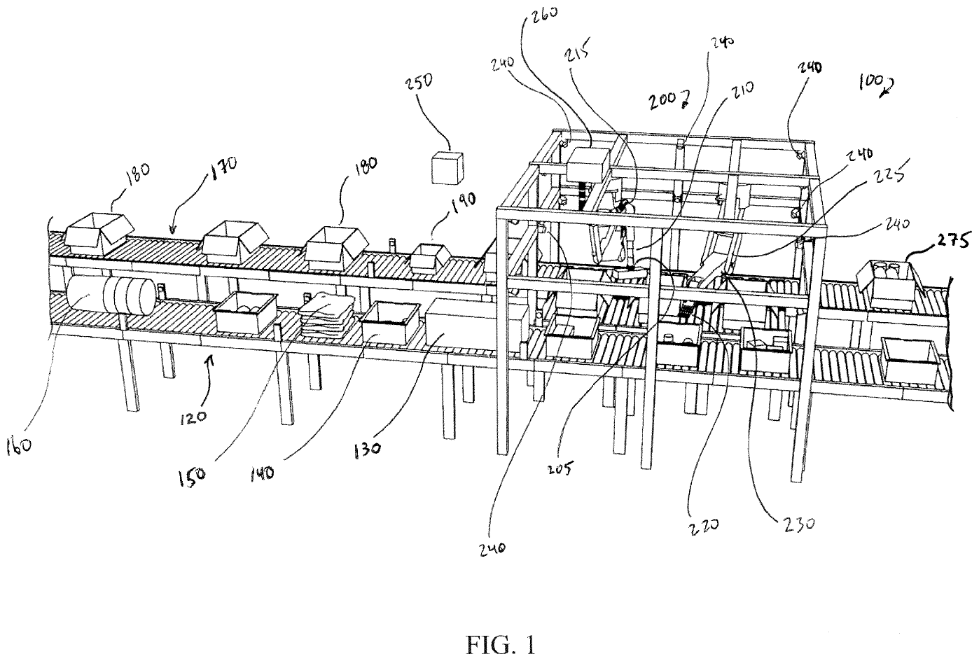

According to an aspect of the invention, a system is provided with a plurality of programmable motion systems for parallel and simultaneous processing of robotic material handling. FIG. 1, for example, shows an autonomous object processing system 100 with an in-feed conveyor 120 with a discontinuous stream of objects to process, including illustrative examples such as a carton 130, a container or bin 140 containing objects, a stack of fabric items such as clothing 150, and a bucket 160. An output conveyor 170 is represented as a stream of shipping boxes 180 and 190 with completed order boxes 275 and processed objects exiting the system 100.

An end-effector system 200 is shown with two programmable motion devices. A first programmable motion device 210 includes a vacuum end-effector 205 supplied with high flow vacuum from blower 260 for grasping objects using a compliant vacuum cup. The first end-effector 205 is mounted on an articulated arm 215. The blower 260, for example, may be a side-channel blower that provides a vacuum with an airflow of at least about 100 cubic feet per minute, and a vacuum pressure at the end-effector of no more than about 65,000 Pascals below atmospheric (e.g., about 50,000 Pascals below atmospheric or 7.25 psi). The high flow vacuum may also be provided by an air-amplifier in accordance with further aspects of the invention. The design is therefore able to better provide pressure at the suction cup when gripping porous or irregularly shaped objects compared with designs where the valve would be in-line. Alternatively, the vacuum end-effector 205 can be supplied with a high vacuum supply, such as from a facility vacuum source or a compressed air venturi that generates vacuum locally to the end-effector system 200 of at least about 90,000 Pascals below atmospheric and a flow rate of at most 5 cubic feet per minute.

In accordance with various aspects, the invention provides that two programmable motion devices may be used each with two different types of end-effectors that compliment each other in terms of functionality and utility. For example, the first end-effector may provide a high flow vacuum cup while the second end-effector may provide an opposing set of grasping devices (not a vacuum cup or other vacuum applicator). The second programmable motion device 230 is provided therefore in accordance with an aspect, with an anthropomorphic end-effector 220 on an articulated arm 225. A perception system having one or a plurality of cameras (e.g., camera 240) are mounted in various positions to provide coverage of the operating space of the first programmable motion device 210 and the second programmable motion device 230. A controller 250 operates to direct the motion of the first programmable motion device 210 and the second programmable motion device 230, the actuation of the blower 260, with input from the cameras 240 and feedback sensors (e.g., positional encoders, force sensors, pressure sensors, etc.) embedded within the respective programmable motion devices 210 and 230.

The end-effector system 200 operates to grasp and move the objects (e.g., cartons 130, bins or totes 140 containing objects, soft-goods 150, and buckets 160) from the in-feed conveyor 120 to the desired location. As shown in FIG. 1, for descriptive purposes only, a representative destination is a stream of shipping boxes 180 and 190. As will be described herein below in greater detail, the first programmable motion device 210 and the second programmable motion device 220 operate effectively simultaneously and in parallel to grasp and move the objects from the in-feed conveyor 120 to the output conveyor 170. Control of the first programmable motion device 210 and the second programmable motion device 220 may be performed by a single controller 250, or control may be distributed between any number of controller 250 elements with a suitable networked interconnection therebetween. The controller 250 provides computer processing controls to the programmable motion devices (210, 230, 315), perception systems (240), and conveyor systems (120, 170, 265) disclosed in the various systems described herein to perform the functions and operations described herein.

FIG. 2 shows an enlarged view of the end-effector system 200 of FIG. 1. The first programmable motion device 210 is shown grasping a cuboid-shaped article 270 with the vacuum end-effector 205 from a bin 140 containing additional identical SKU cuboid-shaped articles 270. The task performed by the first programmable motion device 210 is to grasp a cuboid-shaped article 270 with high flow vacuum provided by blower 260 and move it to a first order container 290, or second order container 295, either of which can be a shipping box 180 from the output conveyor 170 positioned on a buffer conveyor 265. Similarly, the second programmable motion device 230 is shown grasping a cylindrical article 280 from a bin 140 containing identical SKU cylindrical articles 280. The task performed by the second programmable motion device 230 is to grasp a cylindrical article 280 by articulating the anthropomorphic end-effector 220 in a pinched grasp of the cylindrical article 280 and move it to the second order container 295 or the third order container 285, either of which can be yet another shipping box 180 from the output conveyor 170 positioned on the buffer conveyor 265.

The first programmable motion device 210 can operate to fulfill orders destined for the first order container 290 or the second order container 295, and the second programmable motion device 230 can operate to fulfill orders destined for the second order container 295 or the third order container 285 as directed by the controller 250 (shown in FIG. 1) based on input from the cameras 240. Alternatively, each of the first programmable motion device 210 and the second programmable motion device 230 can be directed to deposit items into each of the first order container 290, the second order container 295 and the third order container 285. The control of a plurality of programmable motion devices working simultaneously in proximity requires communication and exchange of motion plans to prevent collisions while maintaining a high degree of utilization (and therefore, increased throughput). Because the first programmable motion device 210 utilizes a vacuum end-effector 205 in the illustrative example of FIG. 2, and the second programmable motion device 230 utilizes an anthropomorphic end-effector 220, the respective programmable motion devices 210 and 230 may be particularly adapted to grasp certain items better than the other and to work cooperatively to perform more complex tasks such as stabilizing a moving object or separating two or more objects. Accordingly, the controller 250, having images of the items acquired from the cameras 240, decoded indicia extracted from the acquired images of the items, and historical data associated with grasping and moving identical SKUs successfully, controls the respective programmable motion devices 210 and 230 to grasp and move the item or items most suitable for the associated end-effector. Additionally, the historical data associated with grasping and moving similar or identical SKUs successfully can be analyzed and compiled so the controller 250 can learn over time certain policies to better adapt to work cooperatively to perform complex tasks. For example, if multiple objects are determined to have been grasped, and if the system has processed one of the detected SKUs in the past, the system may predict how best to process the multi-pick.

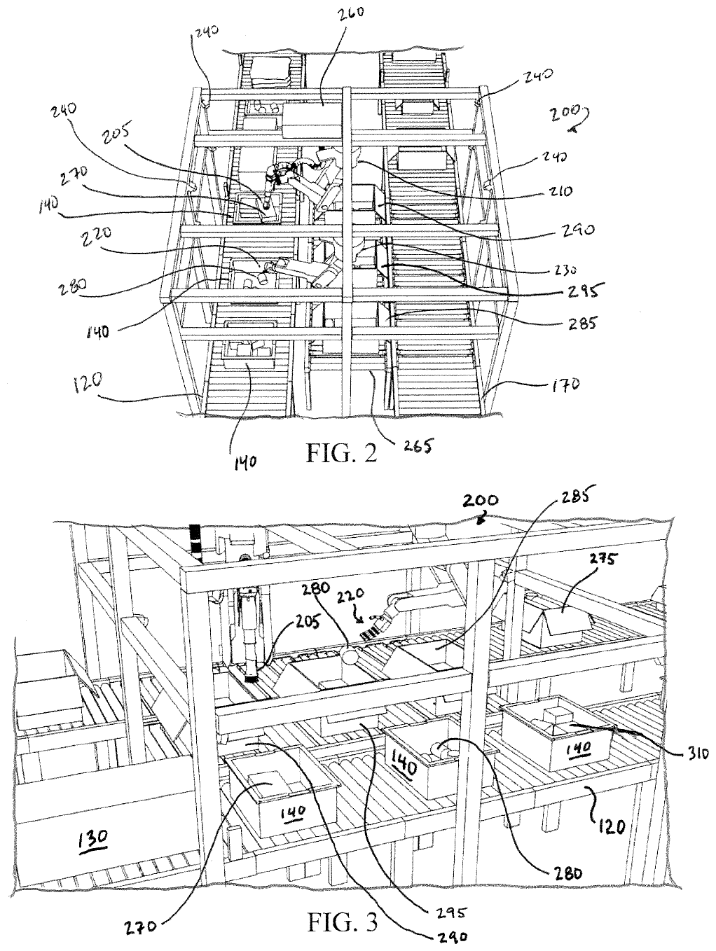

Similarly, with reference to FIG. 3, the end-effector system 200 of FIG. 2 is shown from a further enlarged perspective. The anthropomorphic end-effector 220 is shown depositing the cylindrical article 280 in the second order container 295 with the vacuum end-effector 205 having completed its transfer of the cuboid-shaped article 270. The flow of bins 140 on the in-feed conveyor 120 proceeds from left to right as items such as cylindrical article 280 in a bin 140 and cuboid-shaped article 270 in a bin 140 are picked as needed. A bin 140 with inventory items 310 to be processed is provided to the end-effector system. FIG. 3 shows large carton 310 as the next article to enter the end-effector system 200.

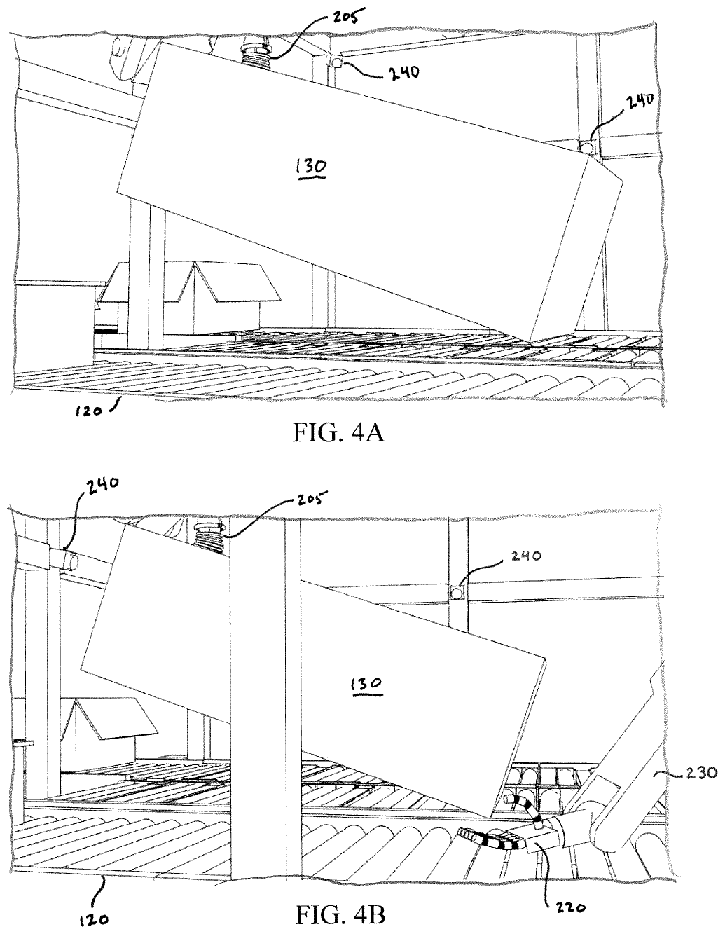

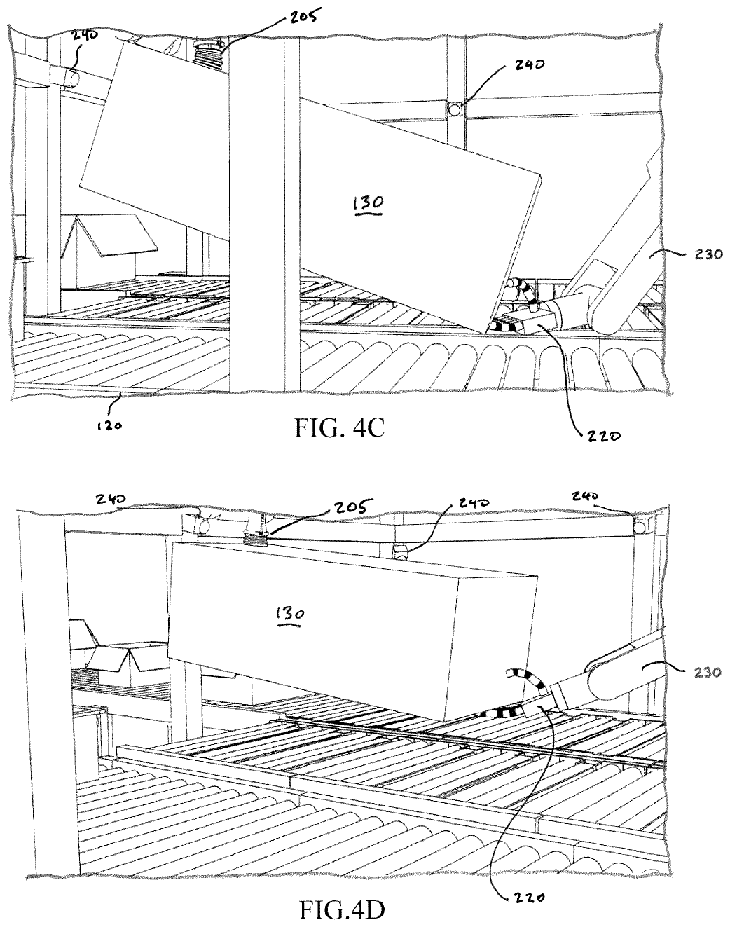

FIGS. 4A-4D show a sequence of events in a first illustrative example showing a task to move an article resulting in motion by the article that does not correspond to an expected motion. FIG. 4A shows a representation of a heavy or large carton 130 in the end-effector system 200. The first programmable motion device 210 with the vacuum end-effector 205 picks the item and unexpected motion resulting from unstable movement of the large carton 130 due to rotation and/or oscillation of the large carton 130 may be observed by cameras 240. The motion resulting from a straight lift of a typical object would likely predict the object to maintain a level orientation with respect to the in-feed conveyor 120, particularly if the grasp location is aligned with the center of gravity of the object. Conventional end-effector systems detecting an unexpected or unstable motion might typically halt the performance of the task and replace the item from where it was picked on the conveyor. A second attempt might select an alternative grasp point to better align the grasp with the center of gravity. Additionally, the end-effector system 200 uses cameras 240 to observe, identify, and track the motion of the picked item, in this illustrative example, the large carton 130. Additionally, tactile or force sensors within either the first programmable motion device 210 with the vacuum end-effector 205 or within the second programmable motion device 230 with the anthropomorphic end-effector 220, may be utilized to sense unbalanced loads, assess a quality of the grip, sense instability, or avoid any damage to the object. As shown in FIG. 4B, upon detection of the unexpected motion, the second programmable motion device 230 with the anthropomorphic end-effector 220 is directed to move toward the large carton 130 to a position where it can make contact with the article, for example, underneath the lowest extent of the article resulting from the unexpected motion. This movement of the second programmable motion device is intended to avoid collision with the moving or oscillating article, which may otherwise cause the vacuum end-effector 205 of the first programmable motion device 210 to lose its grasp. The end-effector system 200 may be reactive to unexpected motion and the resulting cooperative movement, or the end-effector system may proactively engage the cooperative movement of the first programmable motion device 210 and the second programmable motion device 230 based on a policy learned or otherwise constructed.

FIG. 4C shows the second programmable motion device 230 moving to position the anthropomorphic end-effector 220 underneath the large carton 130 as the carton is moving resulting from the movement of the first programmable motion device 210 with the vacuum end-effector 205. The motion of the carton 130 can be directly resulting from the motion induced by the movement of the first programmable motion device 210 and the vacuum end-effector 205 performing the task of moving the carton 130 and/or from the motion induced by the imbalanced grasp that may cause the carton to oscillate as it is suspended. Either way, the cameras 240 and controller 250 identify the article and track the movement of the carton 130 in order to direct the second programmable motion device 230 and the anthropomorphic end-effector 220 to move into a position to contact the carton 130 while it is moving, including, if necessary, matching the oscillating motion of the carton 130. As shown in FIG. 4D, the second programmable motion device 230 with the anthropomorphic end-effector 220, while contacting and supporting the lower side of the carton 130 moves independently of the first programmable motion device 210 with the vacuum end-effector 205, following an independent path necessary to correct the unexpected motion and perform the task resulting in the carton being moved to the desired location (e.g., the buffer conveyor 265 or the output conveyor 170).

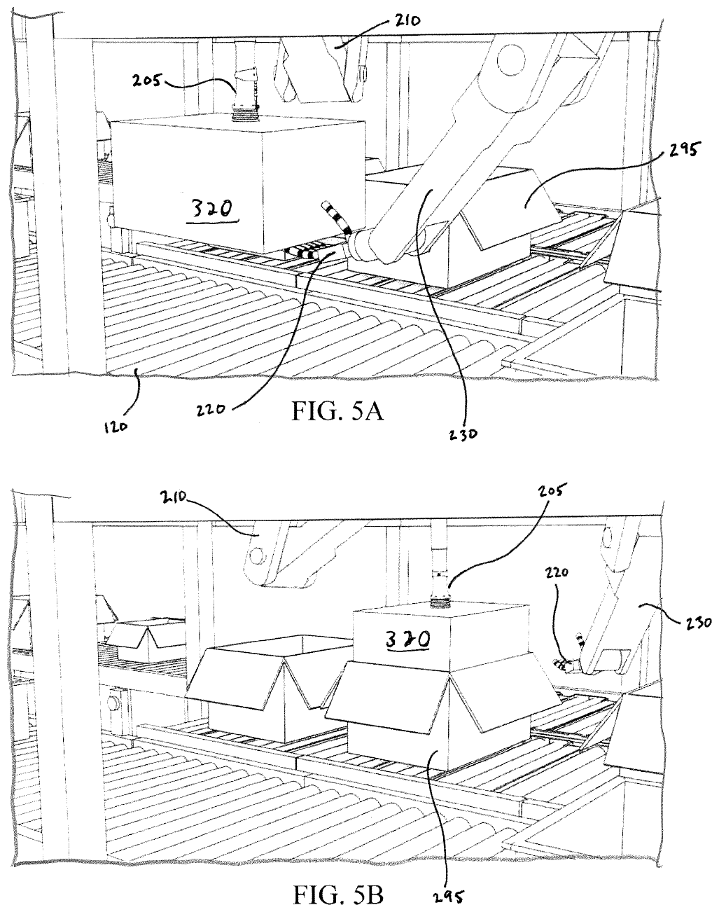

FIGS. 5A and 5B show a series of events in a second illustrative example showing the performance of a task of grasping and moving a carton 320 from the in-feed conveyor 120. The first programmable motion device 210 with a vacuum end-effector 205 has grasped carton 320 and the second programmable motion device 230 with the anthropomorphic end-effector 220 has been directed to assist. The first programmable motion device 210 moves the end-effector 205 with the carton 320 attached by the force of vacuum from blower 260 (shown in FIG. 1) while the second programmable motion device 230 with the anthropomorphic end-effector 220 contacts the carton 320 on a bottom corner. In the illustrative example according to FIGS. 5A and 5B, the desired location is the second order container 295. As shown in FIG. 5B, the second programmable motion device 230 moves the anthropomorphic end-effector 220 out of the way so as to not obstruct with the performance of the task. In this way, the carton can be placed in the second order container 295 to complete the task.

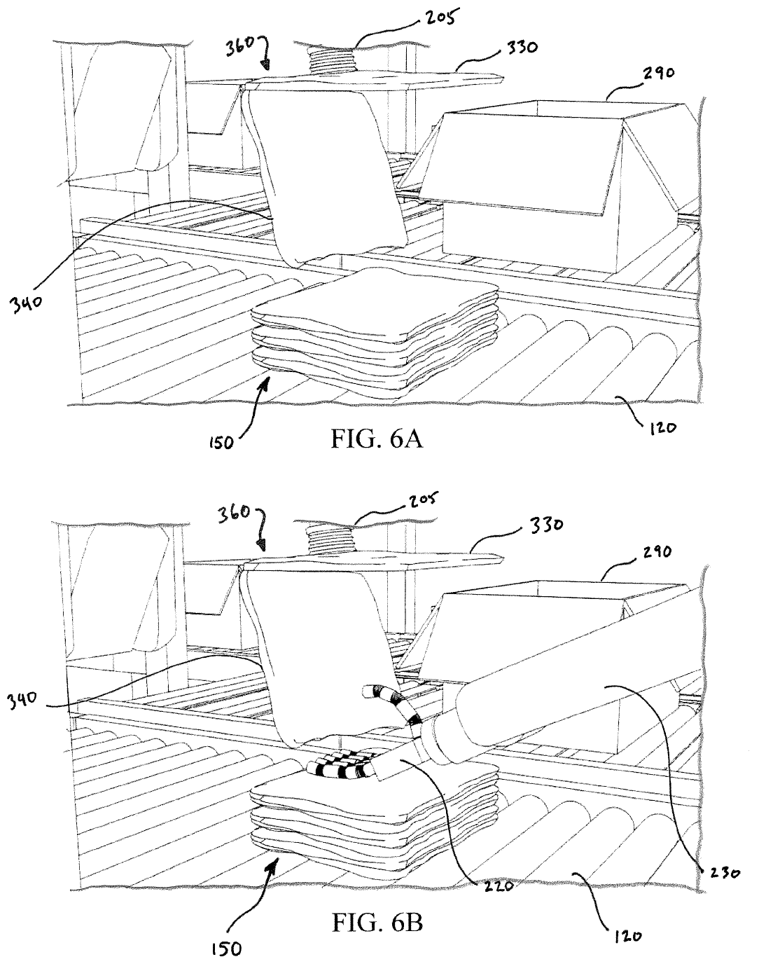

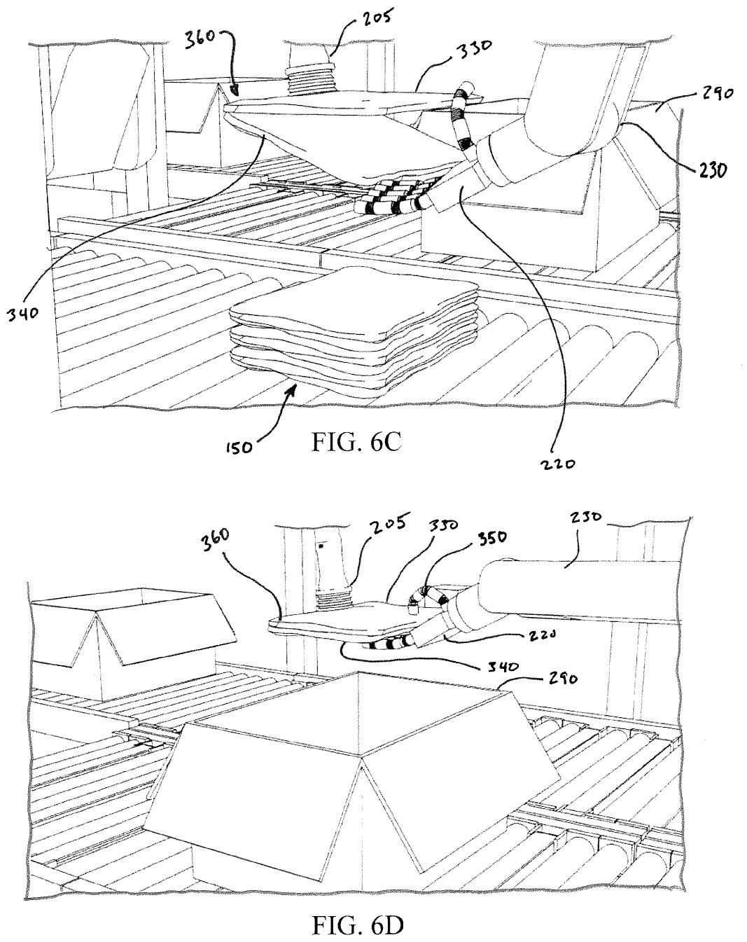

FIGS. 6A-6D show a series of events in a third illustrative example showing the performance of a task of grasping and moving one soft good item 360 in a stack of soft goods 150, such as an article of clothing, from the in-feed conveyor 120 to the first order container 290. The high flow vacuum provided by the blower 260 to the vacuum end-effector 205 is particularly adapted to pick an item of soft goods 360, such as an article of clothing like pants or a shirt, or textile materials like sheets or towels. When individually packaged in a bag, the task is rudimentary; the item is easily picked and placed in the desired location by the vacuum end-effector 205. As shown in FIG. 6A however, if the item of soft-goods 150 is not individually wrapped, or if the soft good item 360 picked from a stack of soft-goods 150 effectively separates or unfolds when picked, the vacuum applied by the vacuum end-effector 205 may not be sufficient to move the item intact. In this case, when the soft-good item 360 is picked, the top portion 330 is captured by the vacuum end-effector 205 but the lower portion 340 unfolds and drops down, creating an unexpected motion as observed by the cameras 240.

As shown in FIG. 6B, the second programmable motion device 230 is then directed to move the anthropomorphic end-effector 220 to a position below the lower portion 340 of the soft good item 360 while the first programmable motion device 210 with the vacuum end-effector 205 is in motion. Again, the first programmable motion device 210 is not required to place the item for a second pick attempt at an alternative grasp location in a way that negatively impacts system throughput. As shown in FIG. 6C, the second programmable motion device 230 is directed to raise the lower portion 340 of the soft-good item 360 using the anthropomorphic end-effector 220 while the first programmable motion device 210 with the vacuum end-effector 205 continues to move in the performance of the task. As shown in FIG. 6D, the anthropomorphic end-effector 220 has adapted into a grip-type grasp of the soft good item 360 using the thumb element 350 of the anthropomorphic end-effector 220 to restore the relative position of the upper portion 330 and the lower portion 340 of the soft good item 360. The task to place the soft good item 360 in the first order container 290 can then be completed.

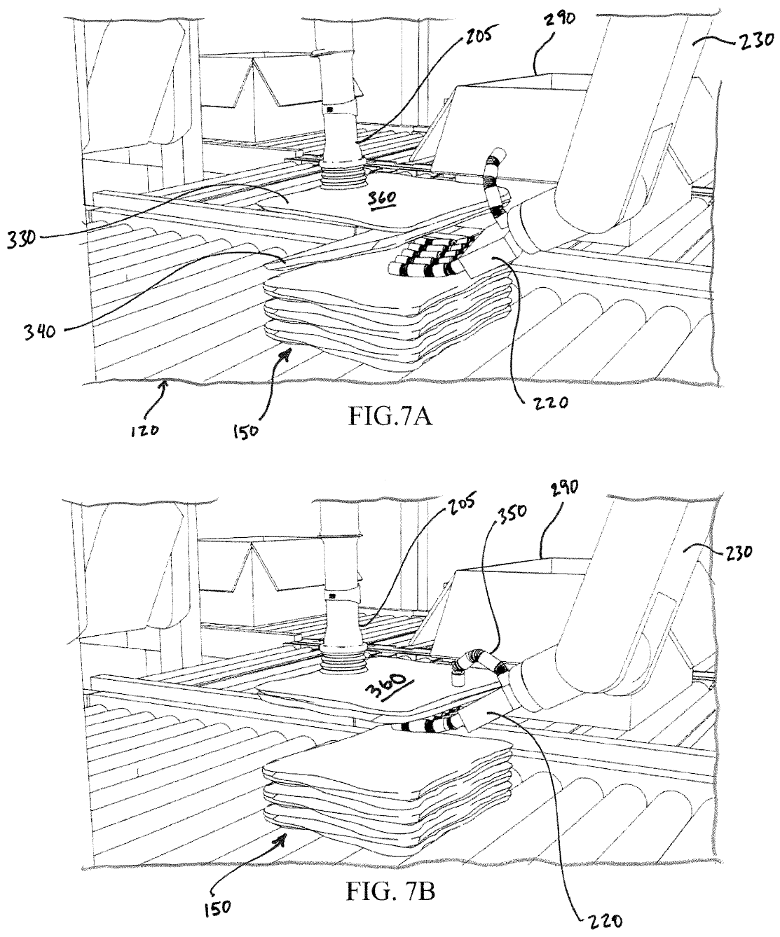

FIGS. 7A-7B show a series of events in a variation of a third illustrative example showing the performance of a task of grasping and moving one soft good item 360 in a stack of soft goods 150, such as an article of clothing, from the in-feed conveyor 120 to the first order container 290. As shown in FIG. 7A, the lower portion 340 of the soft good item 360 is not fully accessible by the anthropomorphic end-effector 220 because the fold between the top portion 330 and the bottom portion 340 is facing the second programmable motion device 230. As shown in FIG. 7B, the second programmable motion device is directed to engage the soft-good item 360 by initiating a grip-type grasp using the thumb element 350 of the anthropomorphic end-effector 220, while the first programmable motion device 210 with the vacuum end-effector 205 is moving to perform the task of grasping and moving the soft-good item 360 to the first order container 290.

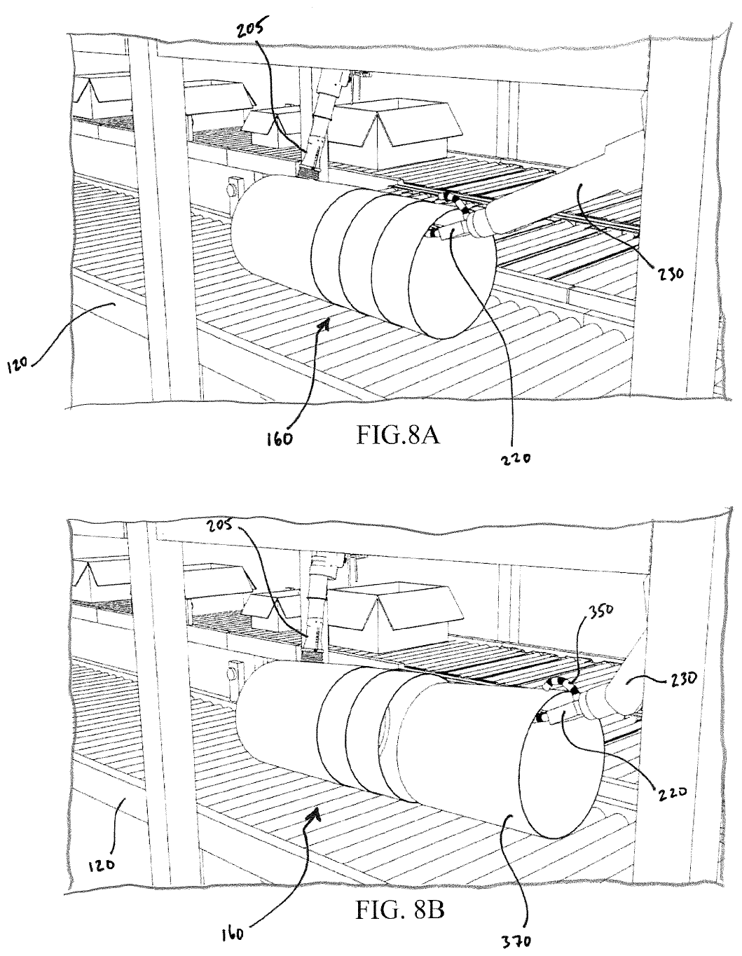

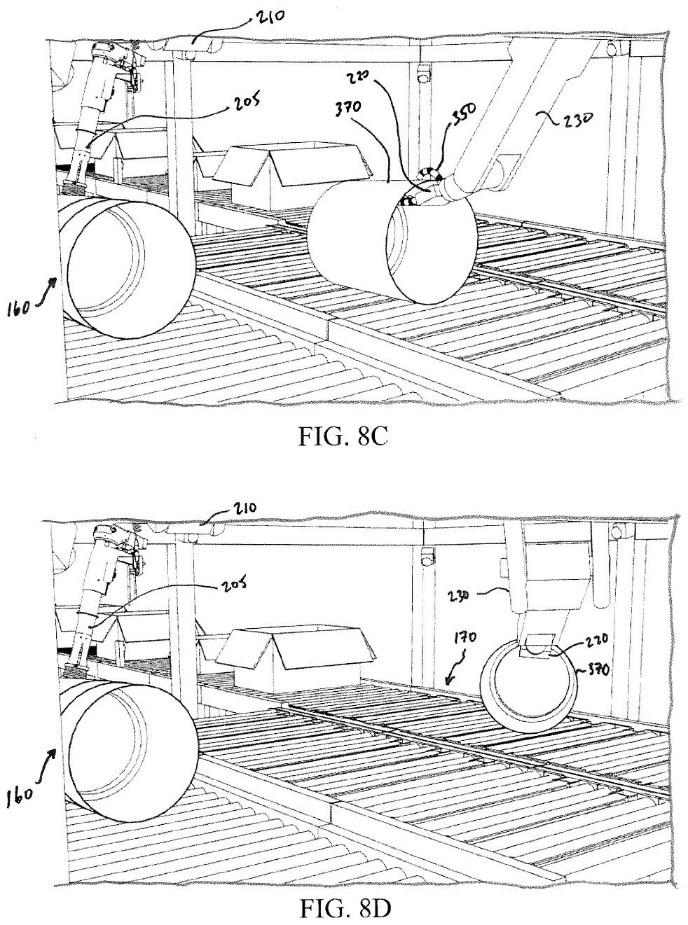

FIGS. 8A-8D show a series of events in a fourth illustrative example showing the performance of a task of grasping and moving nested items such as a nested stack of buckets 160. FIG. 8A shows that when the stack of nested items 160 enters the end-effector system 200 on the in-feed conveyor 120 the first programmable motion device 210 engages the stack of nested items 160 with the vacuum end-effector 205 and through the use of force sensors within the vacuum end-effector 205 and analysis of images acquired from the cameras 240 the controller 250 determines that the size and weight of the engaged stack of nested items 160 does not correlate to the object identification corresponding to a single item of the stack of nested items 160. The second programmable motion device 230 is directed to move the anthropomorphic end-effector 220 to the distant point of the stack of nested items 160 away from the vacuum end-effector 205 and upon contact, grasp the nested stack of items 160.

As shown at FIG. 8B, with the vacuum end-effector 205 grasping on one end of the stack of nested items 160 the second programmable motion device 230 is directed to move away from the vacuum end-effector 205 while the anthropomorphic end-effector 220 is engaged with a grasp-type grip on the stack of nested items 160 using the thumb element 350 of the anthropomorphic end-effector 220. FIG. 8C shows that the second programmable motion device 230 with the anthropomorphic end-effector 220 has extracted a single bucket 370 from the nested stack of items 160. FIG. 8D shows the second programmable motion device 230 completing the task of grasping and moving the single bucket 370 to the output conveyor 170. As will be described in more detail hereinbelow, the remaining stack of nested items 160 can be further processed to de-nest all items of the nested stack of items 160, or exceptions can be suitably processed if the separation of nested items does not reveal a single item to complete the task.

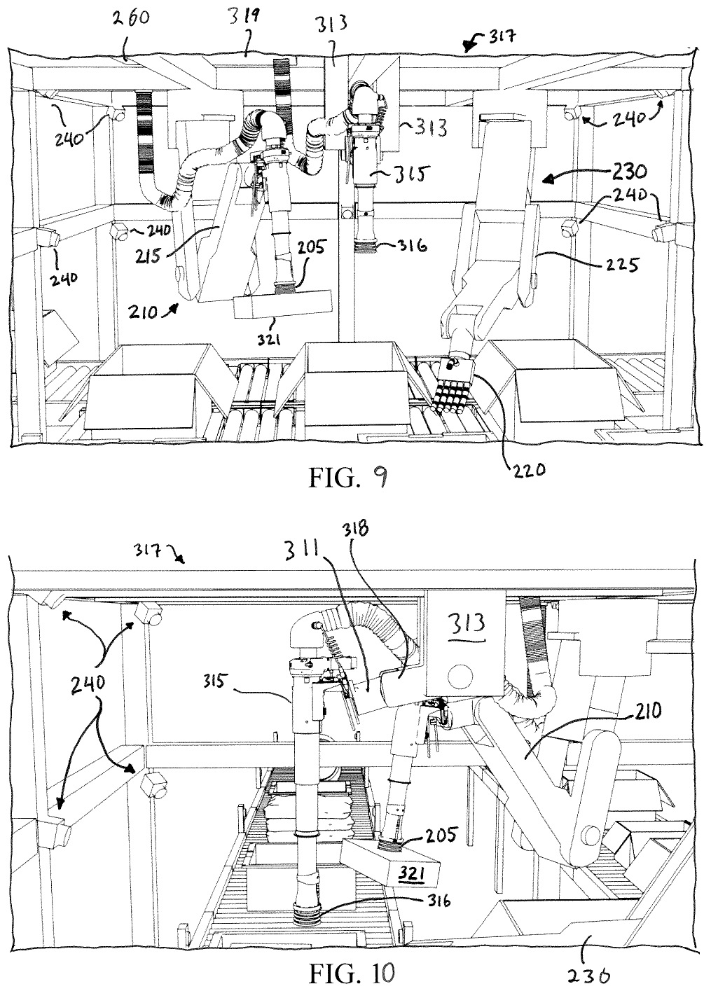

FIG. 9 shows a front view of an end-effector system 317 in accordance with a further aspect of the present invention that includes a third programmable motion device 210. The system 317 includes the first programmable motion device 210 as discussed above with the vacuum end-effector 205 supplied with high flow vacuum or low flow vacuum as described above for grasping objects using the compliant vacuum cup. The first end-effector 205 is mounted on an articulated arm 215. The system 317 also includes the second programmable motion device 230 as discussed above with the anthropomorphic end-effector 220 on the articulated arm 225. A third programmable motion device 315 is also provided that includes a vacuum end-effector 316 supplied with high flow or low flow vacuum as described herein above. The third programmable motion device 315 may be the same or functionally similar to the first programmable motion device 210 or the second programmable motion device 230, or it may be functionally different, as will be described in more detail below. A perception system with one or a plurality of cameras (e.g., camera 240) are mounted in various positions to provide coverage of the operating space of the first programmable motion device 210, the second programmable motion device 230, and the third programmable motion device 315. The controller 250 operates to direct the motion of the first programmable motion device 210, the second programmable motion device 230, the third programmable motion device 315, the actuation of vacuum as applicable, with input from the cameras 240 and feedback sensors (e.g., positional encoders, force sensors, pressure sensors, etc.) embedded within the respective programmable motion devices 210, 230, and 315.

FIG. 10 shows a side view of the end-effector system 317 with a plurality of programmable motion devices. The first programmable motion device 210 is shown moving an object 321 and the action performed by the first programmable motion device 210 does not require the cooperative assistance of either the second programmable motion device 230 (partially visible in FIG. 10) or the third programmable motion device 315. Accordingly, as shown in FIG. 9 and FIG. 10, the third programmable motion device 315 is in a stationary, stand-by position, located such that the first programmable motion device 210 and the second programmable motion device 230 are not obstructed from performing their tasks by the third programmable motion device 315. Alternatively, the third programmable motion device 315 can perform tasks in parallel with the first programmable motion device 210 and the second programmable motion device 230 under the control of the controller 250 or control may be distributed between any number of controller 250 elements with a suitable networked interconnection therebetween. The third programmable motion device 315 may include mount 311 that is rotatable with respect to arm section 318, which in turn is rotatable with respect to attachment portions 313 that attach the device 315 to the support frame. The device 315 include an end-effector 316 that is telescopically extendable downward as shown in FIG. 10, and rotatable to provide a wide range of yawing motion (rotation about a z axis when vertical as shown in FIG. 10). With such extension, the device 315 may be used to stabilize or engage an object, for example, to permit either of the devices 210, 230 to reposition their respective end-effectors on an object. Vacuum may be provided to the end-effector 316 from a vacuum source 319 that is independent of the source.

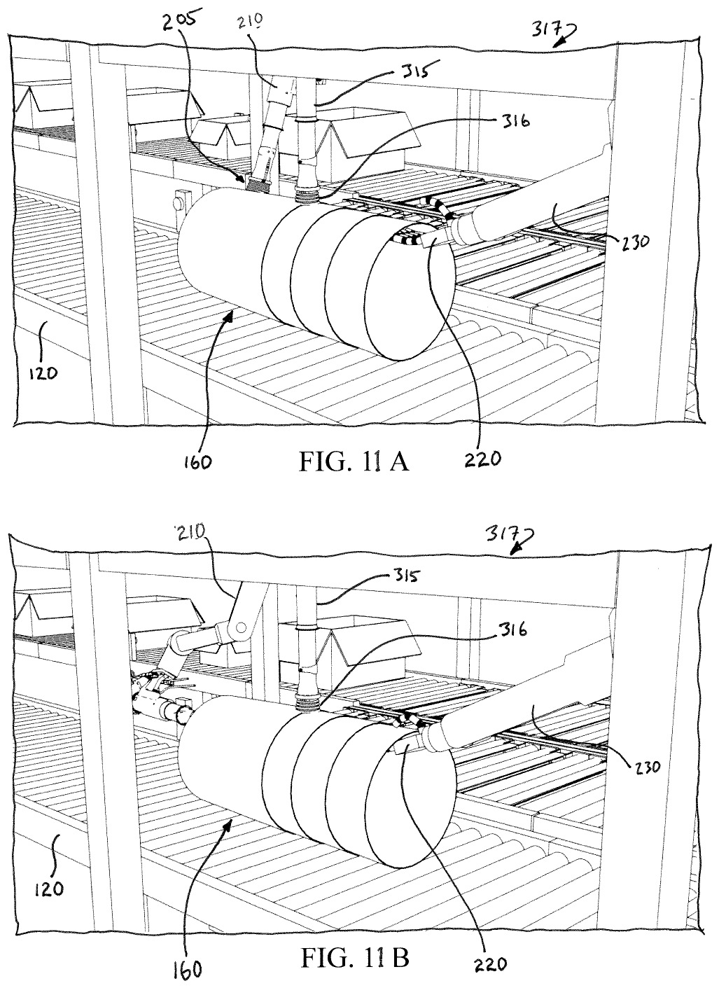

For example, FIGS. 11A-11B show a series of events showing the performance of a task of grasping and moving nested items such as a nested stack of buckets 160 as discussed above with reference to FIGS. 8A-8D. FIG. 11A shows that when the stack of nested items 160 is positioned below the end-effector system 317 on the in-feed conveyor 120 the first programmable motion device 210 engages the stack of nested items 160 with the vacuum end-effector 205 and through the use of force sensors within the vacuum end-effector 205 and analysis of images acquired from the cameras 240 the controller 250 determines that the size and weight of the engaged stack of nested items 160 does not correlate to the object identification corresponding to a single item of the stack of nested items 160. The second programmable motion device 230 is directed to move the anthropomorphic end-effector 220 to the distant point of the stack of nested items 160 away from the vacuum end-effector 205 and upon contact, grasp the nested stack of items 160. The third programmable motion device 315 may then be directed to extend the vacuum end-effector 316 toward, for example, at the mid-point of the stack of nested items 160 and grasp the stack of nested items 160 as shown. Once the third programmable motion device 315 with the vacuum end-effector 316 grasps the nested stack of items 160, the first programmable motion device 210 and the vacuum end-effector 205 and/or the second programmable motion device 230 and the anthropomorphic end-effector 220 may release the grasp and reposition one or both end-effectors 205, 220 to obtain an optimal grasp for de-stacking the stack of nested items 160.

As shown at FIG. 11B, with the first programmable motion device 210 having a repositioned grasp on one end of the stack of nested items 160 and the third programmable motion device 315 grasping the mid-point of the stack of nested items 160, and the second programmable motion device 230 having a repositioned grasp with the anthropomorphic end-effector 220, the first programmable motion device 210 may be directed to move the vacuum end-effector 205 away from the anthropomorphic end-effector 220 while the third programmable motion device 315 and its end-effector 205 remains engaged to the midpoint of the nested stack of items 160. The end-effector 316 may either maintain its grasp on the stacked objects 160 during separation, or may release its grasp during the separation movement, for example, if it determined that the end-effectors 316 and 220 are grasping the same object. The system may, for example, begin the separation functionality while engaging the object with the end-effector 316, but if resistance over a threshold is detected, the system may release the grasp on the object by the end-effector 316. In this way, at least one of the plurality of programmable motion devices in the end-effector system 317 may extract one item of the nested stack of items 160. The remaining stack of nested items 160, if any, may be further processed to de-nest all items of the nested stack of items 160, or exceptions can be suitably processed if the separation of nested items does not reveal a single item to complete the task. The function of the third programmable motion device 315 need not be limited by the form and function of an end-effector as it provides support to the object and cooperatively assists at least one of the first programmable motion device 210 and the second programmable motion device 230 with the handling of objects.

The flexibility of the end-effector system 200 and the end-effector system 317 of the present invention requires that all SKUs to be processed by the system can be handled by the autonomous robotic systems without requiring manual or human interaction exceptions. In the end-effector system 200 and the end-effector system 317 of the previously described illustrative examples, the flexibility of the system is provided through the use of at least a vacuum end-effector 205 and an anthropomorphic end-effector 220.

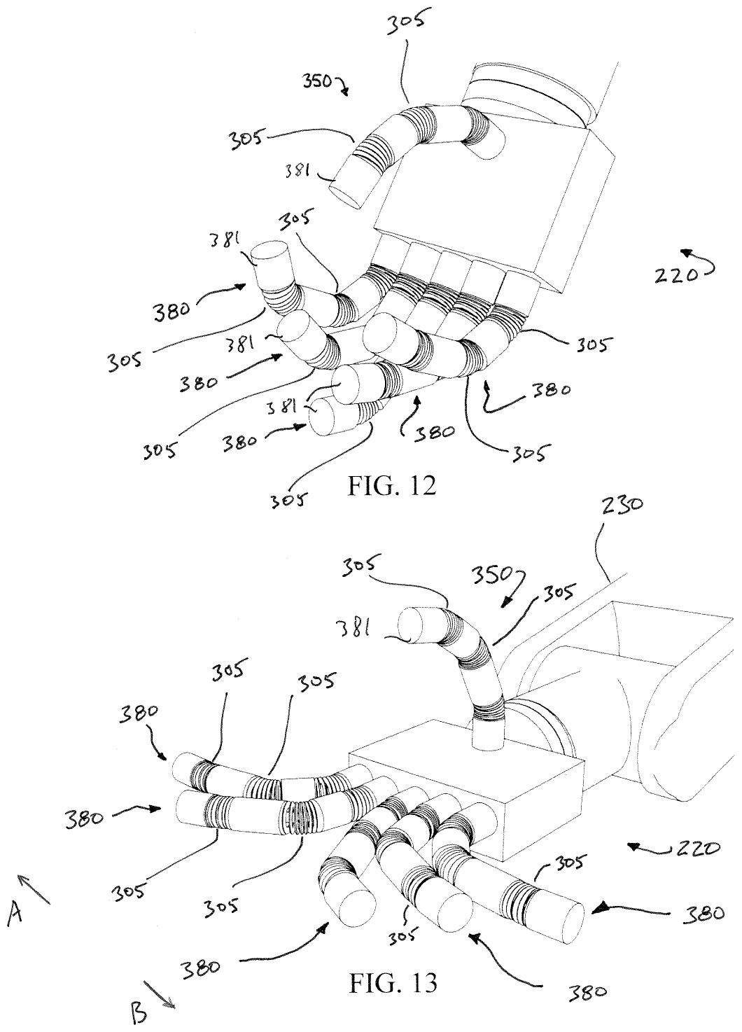

FIG. 12 shows the anthropomorphic end-effector 220 as a mechanical gripper with a thumb element 350 opposing gripper digits 380. Each of the thumb element 350 and the gripper digits 380 are individually controllable with a proximal end flexibly attached to the base of the anthropomorphic end-effector 220 and the distal end positionable through actuation of flexible couplings 305 to cooperatively form a pinch grip between a single or multiple gripper digit 308 and the thumb element 350. FIG. 13 shows the thumb element 350 in a retracted position to not cause a grip-type grasp of an item with the gripper digits 380 forming a plane to provide support of items in an assist movement with actuation of the flexible couplings 305 to position the gripper digits 380 to be spread in opposing directions (shown at direction A and at direction B).

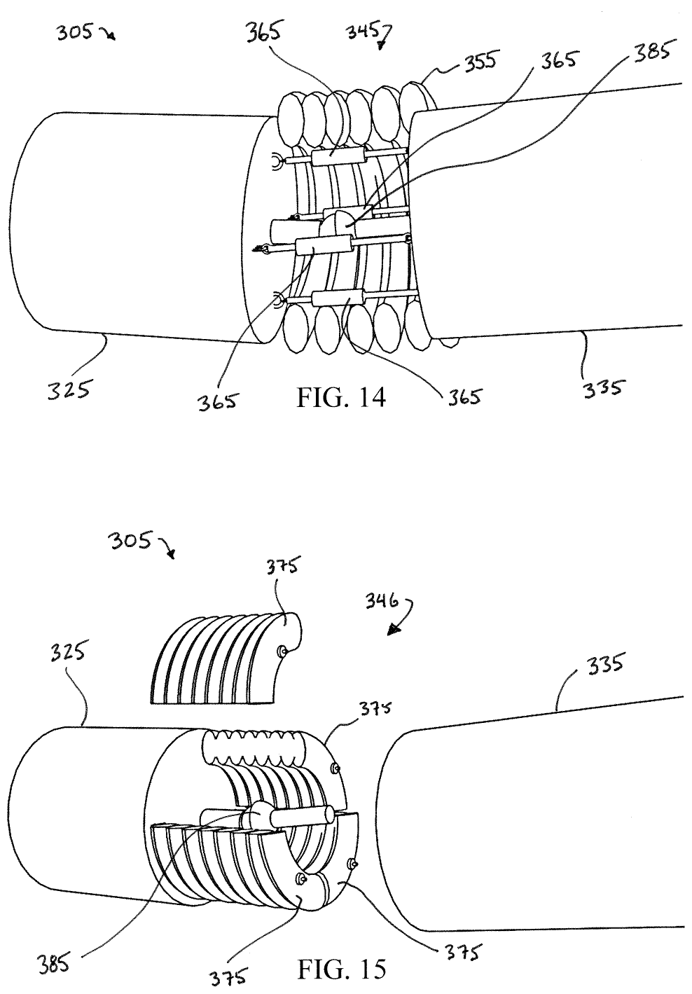

FIG. 14 shows a flexible coupling 305 of the anthropomorphic end-effector 220 as a first articulating joint 345 in accordance with an aspect of the present invention that includes at least one linear actuator 365. When disposed between a first element 325 of the anthropomorphic end-effector 220 and a second element of the anthropomorphic end-effector 220, the linear actuator 365 is selectively and individually extendible and retractable so that the relative position of the first element 325 to the second element 355 can be changed. A central ball joint 385 can be placed between the first element 325 and the second element 335 to maintain the separational distance while permitting rotational translation. A dust boot 355 can be positioned at the flexible coupling 305 to protect the internal components from dust and environmental exposure.

The linear actuators 365 in the flexible coupling 305 can be provided as pneumatic actuators that selectively and individually extend and retract with the application of compressed air or fluid. The linear actuators can alternatively be spring-biased vacuum actuators that selectively and individually retract upon the application of vacuum and extend with the absence of vacuum due to a spring bias. In either of these aspects, a series of valves with fluidic transport must be provided to each of the flexible couplings 305 with control signals wirelessly transmitted to the anthropomorphic end-effector 220. Alternatively, the linear actuators 365 can be electromechanical motor-driven linear drives that rotate a threaded shaft to extend or retract in a motion corresponding to the motor rotation direction. In this aspect, control signals can directly drive the individually selected and actuated linear actuators 365.

FIG. 15 shows a partial exploded view of the flexible coupling 305 of the anthropomorphic end-effector 220 as a second articulating joint 346 in accordance with an aspect of the present invention that includes a plurality of vacuum actuators 375. When disposed between a first element 325 of the anthropomorphic end-effector 220 and a second element of the anthropomorphic end-effector 220, any one or all of the plurality of vacuum actuators 375 can be selectively and individually retracted through the application of a vacuum source so that the relative position of the first element 325 to the second element 355 can be changed. In an aspect, the application of vacuum on one of the plurality of vacuum actuators 375 will result in an angular translation of the first element 325 relative to the second element 355. The other ones of the plurality of vacuum actuators 375 can be vented to atmosphere or isolated at atmosphere to be held in a rigid form as the one of the plurality of vacuum actuators 375 with vacuum applied collapses when evacuated. A ball joint 385 like that of FIG. 14 (not shown for clarity) is optional as the rigidity of the second articulating joint 346 can be maintained through the selective application of vacuum to the respective ones of the plurality of vacuum actuators 375. Control of the second articulating joint 346 can be provided through a series of individually actuated valves coupling each of the plurality of vacuum actuators 375 to the vacuum source 319. When assembled, each of the plurality of vacuum actuators 375 are attached at one end to the first element 325 of the anthropomorphic end-effector 220 and attached at the second element of the anthropomorphic end-effector 220. Control valves for each of the plurality of vacuum actuators 375 can reside within the anthropomorphic end-effector 220 with control signals wirelessly transmitted to the anthropomorphic end-effector 220.

The aspects of the present invention relating to the operation of the anthropomorphic end-effector 220 as described herein may be provided by a variety of further functionalities to provide an anthropomorphic end-effector 220 with individually and separately actuated gripper digits 380 and/or thumb elements 350 to provide a pinch-grip or grasping plane. Additionally, the fingers may include the gripper digits 380 (e.g., outer gripper digits 381 shown in FIG. 12) formed with an outer polymeric or elastomeric material (such as polypropylene or rubber) that provides a desired tackiness or stickiness. Additionally, any of the digits 380 may include engagement features (again, e.g., on outer gripper digits 381) such as hook fabric of hook and loop fasteners for facilitating engagement with objects.

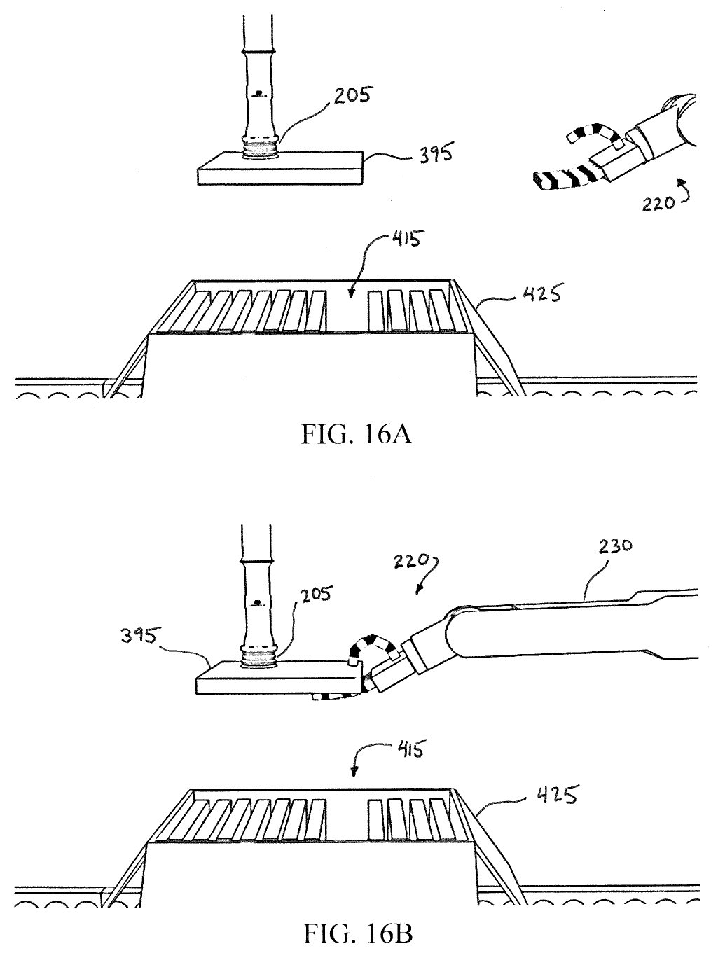

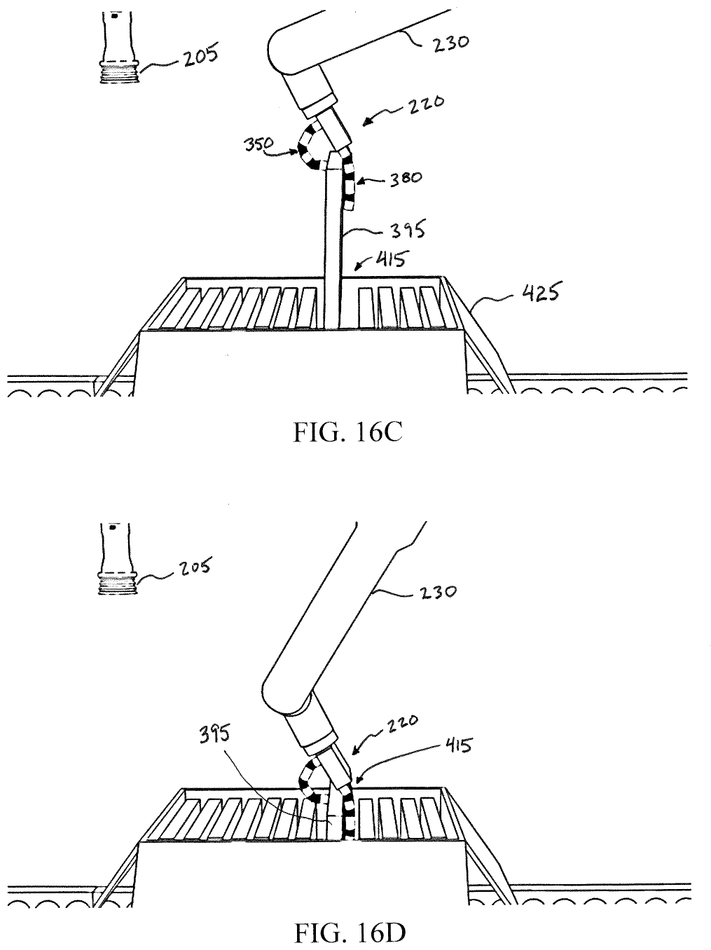

FIGS. 16A-16D show a series of events in a fifth illustrative example showing the performance of a task of cooperatively grasping and moving an item at a location for object handling where the use of a single programmable motion device and conventional vacuum end effector may not be suitable. FIG. 16A shows the first end-effector 205 and the anthropomorphic end-effector 220 of the object processing system 100 described above with reference to FIG. 1. As shown in FIG. 16A, the first end-effector 205 has grasped a high aspect ratio object 395, where the constraints inherent with the dimensional characteristics of the object 395 limit the locations upon which the object 395 can be grasped by the first end-effector 205. While a conventional vacuum cup end-effector is particularly well adapted to grasp such an item with a sufficiently broad grasp position, placing the object 395 into the required position 415 in the destination container 425 cannot readily be performed. In order for the first end-effector 205 to place the object 395 into the required position 415 in the destination container 425, a grasp would be necessary at the narrow end of the object, which could have an insufficient grasp area to establish a reliable grasp. FIG. 16B shows the anthropomorphic end-effector 220 moving cooperatively with the first end-effector 205 to grasp object 395 while the grasp of object 395 is maintained by the first end-effector 205. FIG. 16C continues the sequence, showing the first end-effector 205 having released its grasp of the object 395 and moved away. The second programmable motion device 230, with the anthropomorphic end-effector 220 having full grasping control of the object 220 with a pinch grip by gripping digits 380 and thumb element 350 can readily align the object 395 into the desired orientation to fit in the required position 415. Finally, FIG. 16D shows the full progression of the sequence with the second programmable motion device 230 moving the anthropomorphic end-effector 220 to fully insert the object 395 into the required position 415 so that the anthropomorphic end-effector 220 can release its grip to complete the sequence.

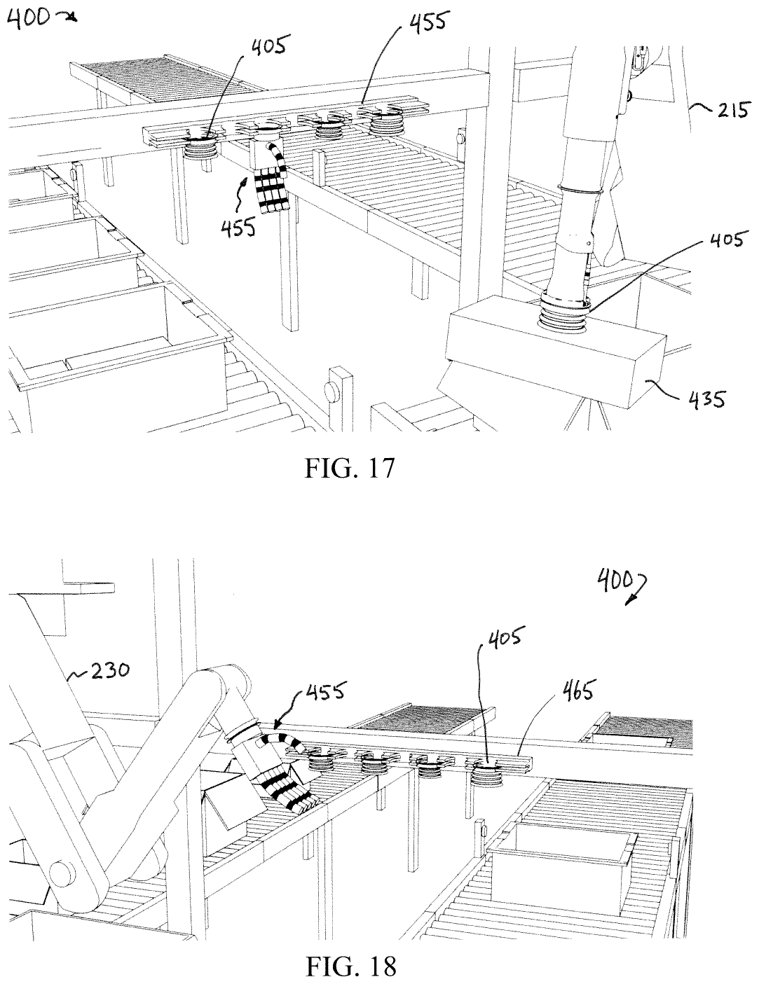

According to yet another aspect of the invention, FIG. 17 and FIG. 18 collectively depict each of two programmable motion devices that may be used with any combination of types of end-effectors that complement each other in terms of functionality and utility with the ability to change end effectors. FIG. 17 shows an end-effector system 400 with the first articulated arm 215 shown grasping an object 435 with a swappable vacuum cup end effector 405. A first end effector rack 455 is within the reachable range of the first articulated arm 215, shown with various swappable vacuum cup end effectors 405 and a swappable anthropomorphic end-effector 455. Similarly, FIG. 18 shows the end effector system 400 with the second articulated arm 230 with a swappable anthropomorphic end-effector 455 attached thereto, available to assist the first articulated arm 215 with either of the swappable vacuum cup end-effector 405 or the swappable anthropomorphic end-effector 455 attached thereto. Conversely, the second articulated arm 230 can remove the swappable anthropomorphic end-effector 455 and replace the same with a vacuum end-effector 405 using the second rack 465, which is placed within the operational range of the second articulated arm 230. Each of the swappable vacuum end-effectors 405 and the swappable anthropomorphic end-effector 455 have a magnetic base that attach to an electromagnetic adapter at the connection site of the respective first articulating arm 215 or second articulating arm 230. The flexibility provided by the various combinations of end effectors available to the two programmable motion devices of the end effector system 400, and the cooperative grasping and handling afforded by the combination, operate to improve the efficiency, throughput, and accuracy of the object handling systems.

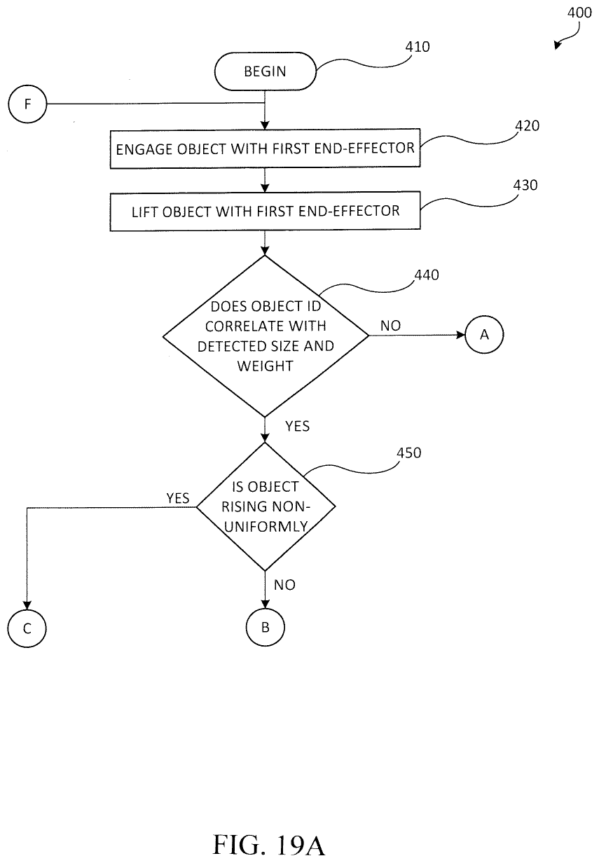

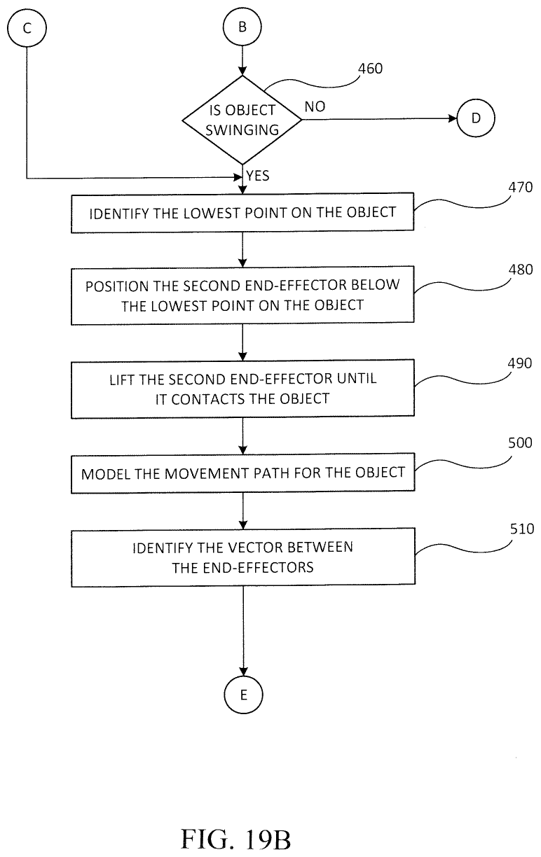

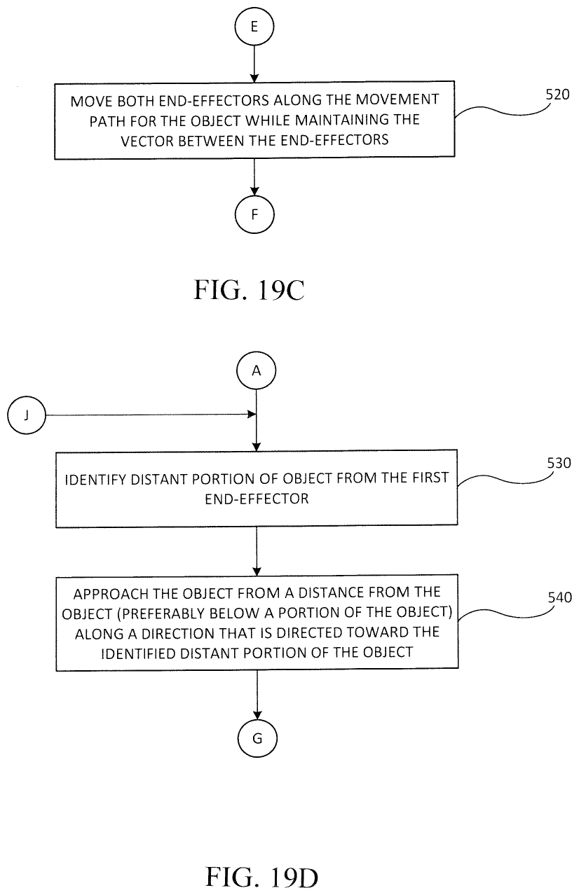

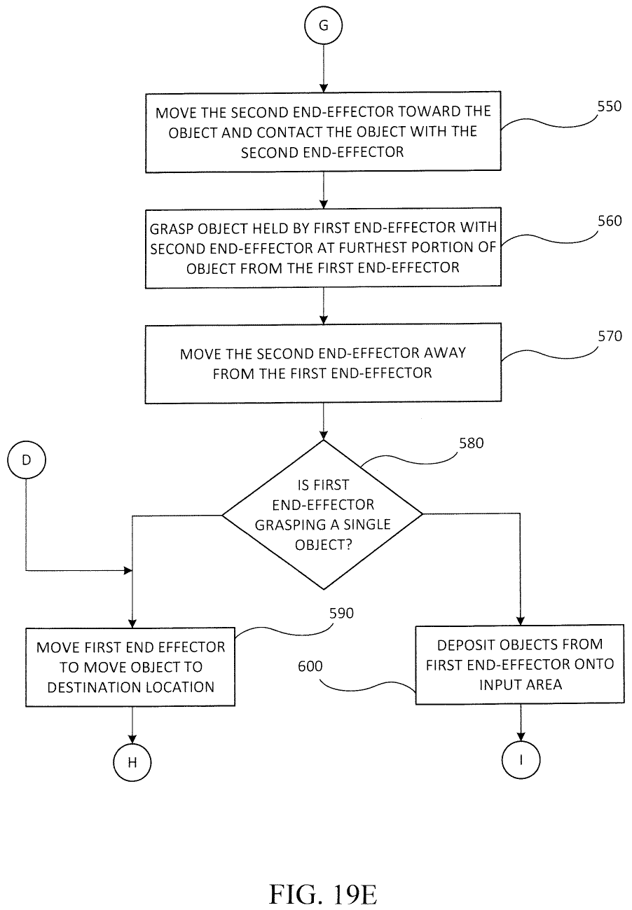

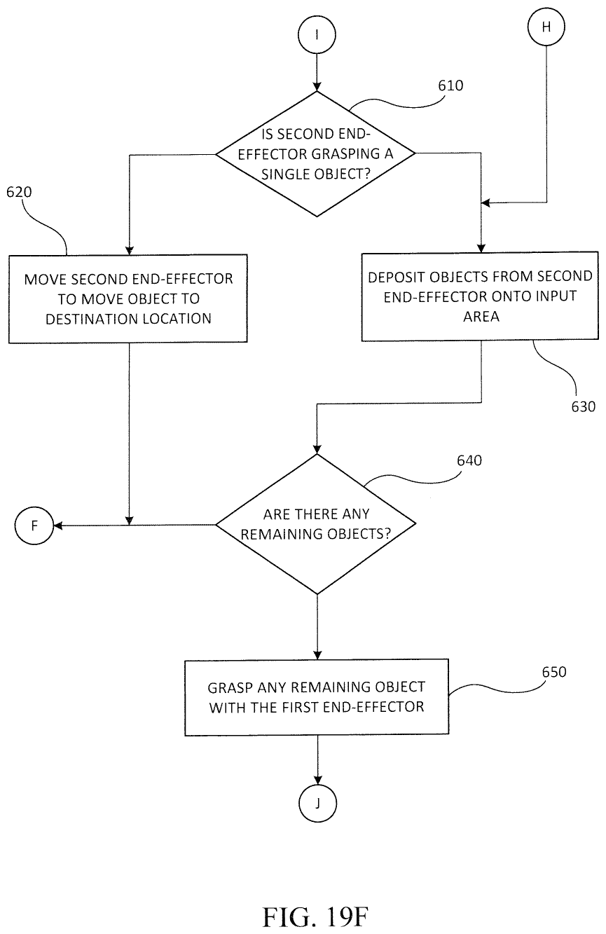

The method of the present invention is described in more detail with reference to FIGS. 19A-19F. As described above regarding the illustrative examples, the end-effector system 200 within the object processing system 100 is presented with the task of grasping and moving articles from the in-feed conveyor 120 to create completed orders 275.

FIG. 19A shows the method of the present invention beginning at step 410 when an inventory item 390 enters the end-effector system 200 as an object to be processed. At step 420 the first end-effector engages the object and at step 430 the first end-effector lifts the object for processing. At step 440, the controller determines if the identification of the object established from an analysis of the images of the object acquired by the cameras 240 correlates to the detected size and weight of the object lifted by the first end-effector. If the correlation does not match within a preset threshold, processing continues at input A of FIG. 19C. Otherwise, as the object is being lifted, as observed by the controller performing analysis of images acquired by the cameras 240, a determination is made whether the object is rising non-uniformly, or if an unexpected motion profile is observed. If non-uniform motion is observed, processing continues at input C of FIG. 19B. Otherwise, processing continues at input B of FIG. 19B.

FIG. 19B input B leads to step 460 where the controller performing analysis of images acquired by the cameras 240 determines whether the object exhibits a swinging or oscillating motion as the object is being moved by the first end-effector. If not, (i.e., if the motion of the object matches the motion plan of the first end-effector) processing continues at input D of FIG. 19D. If the object is swinging, and with input C for objects not rising uniformly, processing continues to step 470 where the lowest point of the object is identified by the controller performing analysis of images acquired by the cameras 240. At step 480, the second end-effector is directed to move below the lowest point on the object, and at step 490, the second end-effector lifts until it contacts the object. It is important to note again that motion of the first end-effector with the object attached does not stop provided the object continues to be held by the first end-effector. Accordingly, the second end-effector may require motion planning to match the motion of the first end-effector and the relative motion of the object being moved. As described above regarding the illustrative examples, an oscillating or swinging object that is also moving according to the motion plan of the first end-effector will need to be approximated by the second end-effector to contact the object at step 490. Once contact with the object is made by the second end-effector, processing continues at step 500 where the movement path for the object to continue the task of moving the object to the desired location is performed. At step 510, vectors between the first end-effector and the second end-effector are identified to cooperatively move the object. Processing then continues at input E of FIG. 19C.

FIG. 19C shows processing continuing at input E where at step 520 both end-effectors cooperatively moving the object move along the movement path while maintaining the vector between the two end-effectors. Processing continues at input F at FIG. 19F. Processing at input A from output A at FIG. 19A and input J from output J at FIG. 19D (described herein below) proceeds to step 530 where the distant portion of the object from the first end-effector is identified. At step 540, the second end-effector approaches the object, preferably from below, along a direction that is directed toward the distant portion of the object identified at step 530. Processing continues at input G of FIG. 19E.

FIG. 19E shows processing continuing at input G where at step 550 the second end-effector moves toward the object and contact the object with the second end-effector. At step 560 the object held by the first end-effector is grasped by the second end-effector. At step 565, shown in dashed form, provides the option of deploying a third end-effector, as described with reference to FIGS. 11A and 11B regarding the end-effector system 317, which permits the first end-effector or the second end-effector to reposition while the object is grasped by the third end-effector. At step 570, the second end-effector is moved away from the first end-effector, effectively pulling apart the object. Now both the first and the second end-effector are holding at least one of the objects. At step 580 the controller performing analysis of images acquired by the cameras 240 and referring to data collected from within the first end-effector, determines if the first end-effector is grasping a single object. If so, along with processing from output D of FIG. 19B, processing continues to step 590 where the first end-effector is directed to move the object to the destination location. Processing continues at input H of FIG. 19F. If at step 580 the first end-effector is not holding a single object, the first end-effector is directed to move the objects back to the input area of the end-effector system 200 for repeat processing and processing continues at input I of FIG. 19F.

FIG. 19F starts with input I from output I of FIG. 14D where at step 610 the controller performing analysis of images acquired by the cameras 240 and referring to data collected from within the second end-effector, determines if the second end-effector is grasping a single object. If so, the second end-effector is directed at step 620 to move the object to the destination location thereby completing the task and returning to input F of FIG. 19A. If it is determined the second end-effector is not grasping a single object at step 610, along with output H from FIG. 19E, the second end-effector is directed to return the objects back to the input area at step 630. Processing continues to step 640 where it is determined if there are any remaining objects necessary to complete the task. If not, the task is completed, and processing returns to input F of FIG. 19A. If objects remain for processing, the first end-effector is directed to grasp the remaining multiple nested objects from the input area at step 650 and processing continues at input J of FIG. 19D.

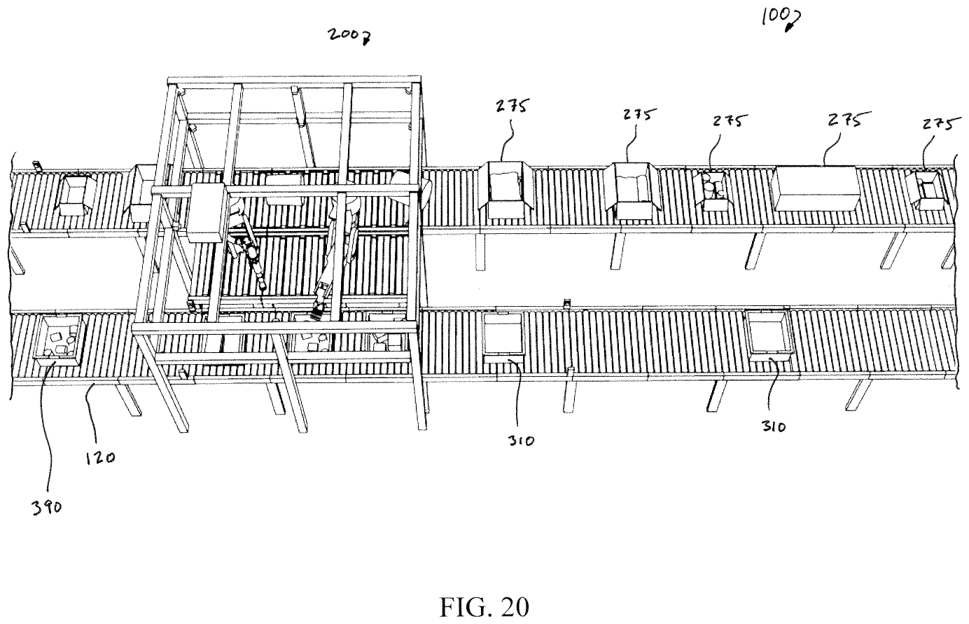

With reference to FIG. 20, the system therefore provides that all input objects (e.g., from containers or bins 390) on input conveyor 120 may be processed by the object processing system 200 whether they be rigid objects in bins, soft or otherwise non-rigid objects, large or heavy objects or multiple (e.g., stacked) objects that require being separated prior to being processed to provide processed articles 275. Each object (for example) may be processed by any of being placed into a designated destination output bin, or by being placed onto the intermediate bidirectional conveyor (by which the object is then moved to the output conveyor, or by being placed directly onto a designated placement on to the output conveyor).

Those skilled in the art will appreciate that numerous modifications and variations may be made to the above disclosed embodiments without departing from the spirit and scope of the present invention.

What is claimed is:

1. An end-effector system for use with a programmable motion device, said end-effector system comprising:
a first end-effector for performing a task of grasping and moving an object from an input area to an output area, the first end-effector including a vacuum cup gripper;
a second end-effector for grasping and moving the object to assist the task performed by the first end-effector, said second end-effector including a non-vacuum gripper; and
a control system comprising at least one camera for detecting movement of the object associated with the task, the control system directing the second end-effector to contact the object and move in a motion corresponding to the movement of the object associated with the task, and the control system directing the first end-effector for grasping the object and the second end-effector for contacting the object to cooperatively move the object to the output area to complete the task.

2. The end-effector system of claim 1, wherein the control system directing the second end-effector for contacting the object includes directing the second end-effector to perform a lifting motion from below the object.

3. The end-effector system of claim 1, wherein the control system detecting movement of the object includes detecting an oscillating motion of the object.

4. The end-effector system of claim 3, wherein the control system directing the second end-effector to contact the object includes directing the second end-effector to match the oscillating motion.

5. The end-effector system of claim 1, further comprising the control system determining the object is at a desired location and directing the second end-effector to release contact with the object and move away from the object before the first end-effector releases the grasp.

6. The end-effector system of claim 1, wherein the first end-effector is coupled to a high flow vacuum source.

7. The end-effector system of claim 6, wherein the high vacuum source is provided by a high flow vacuum blower that supplies vacuum pressure to the vacuum cup gripper.

8. The end-effector system of claim 1, wherein the first end-effector provides a high vacuum source.

9. The end-effector system of claim 7, wherein the second end-effector is an anthropomorphic end-effector.

10. An object processing system comprising:
a first programmable motion device with a first end-effector for performing a task of grasping and moving an object from an input area to an output area;
a second programmable motion device with a second end-effector for engaging and moving the object to assist the task performed by the first end-effector, the second end-effector of the second programmable motion device including different functionality than that of the first end-effector of the first programmable motion device; and
a control system comprising at least one camera for detecting movement of the object by the first end-effector of the first programmable motion device and directing the second programmable motion device to engage the object with the second end-effector of the second programmable motion device while the object is moving, the control system directing the first programmable motion device and the second programmable motion device for cooperatively moving the object to the output area to complete the task.

11. The object processing system of claim 10, wherein the control system directing the second programmable motion device to engage the object with the end-effector of the second programmable motion device directs the second programmable motion device to position the second end-effector below a lowest point on the object and then lifting the second end-effector to engage the object.

12. The object processing system of claim 10, wherein the second end-effector of the second programmable motion device is an anthropomorphic end-effector.

13. The object processing system of claim 10, includes a third programmable motion device with a third end-effector.

14. A method of processing objects with a first programmable motion device and a second programmable motion device, the method comprising:
grasping and moving an object from an input area using a first end-effector of the first programmable motion device, the first end-effector using a first functionality for grasping and moving the object;
determining that the second programmable motion device with a second end-effector is needed to assist the first programmable motion device in grasping and moving the object, the second end-effector using a second functionality for grasping and moving the object that is different than the first functionality; and
contacting the object with the second end-effector while the object is moving to assist in moving the object by the first programmable motion device.

15. The method of claim 14, wherein the first end-effector of the first programmable motion device and the second end-effector system of the second programmable motion device are used to separate the object into plural objects.

16. The method of claim 14, wherein determining is responsive to the object moving.

17. The method of claim 14, wherein determining is responsive to a determination that the weight of the object is much higher than expected.

18. The method of claim 14, wherein the method further includes grasping the object with a third end-effector of a third programmable motion device.

19. The method of claim 14, wherein the method further includes placing the object at a destination location in a pose caused by the transfer from the first end-effector to the second end-effector.

20. The method of claim 14, wherein the method further includes exchanging each of the first end-effector and the second end-effector with a different end-effector.
